(19) United States
(12) Patent Application Publication
(10) Pub. No.: US 2026/0046953 A1
(43) Pub. Date: Feb. 12, 2026

(54) METHOD AND APPARATUS FOR SENDING NOTIFICATION MESSAGE IN MULTI-HOP UE-TO-NETWORK RELAY COMMUNICATION IN A WIRELESS COMMUNICATION SYSTEM

(71) Applicant: ASUS Technology Licensing Inc., Taipei City (TW)

(72) Inventors: Chen-Hsiang Hung, Taipei City (TW); Li-Te Pan, Taipei City (TW); Yu-Hsuan Guo, Taipei City (TW)

(21) Appl. No.: 19/286,111

(22) Filed: Jul. 30, 2025

Related U.S. Application Data
(60) Provisional application No. 63/679,997, filed on Aug. 6, 2024.

(51) Int. Cl. H04W 76/14; H04W 24/08; H04W 76/19; H04W 76/20; H04W 88/04; H04W 92/18

(52) U.S. Cl. CPC H04W 76/14; H04W 24/08; H04W 76/19; H04W 76/20; H04W 88/04; H04W 92/18

(57) ABSTRACT

Methods, systems, and apparatuses are provided for sending notification messages in multi-hop User Equipment (UE)-to-network (U2N) relay communications by intermediate relays in a wireless communication system, wherein a method comprises establishing a first PC5 connection with a remote UE for supporting a U2N relay communication between the remote UE and a network via the first relay UE and a second relay UE, establishing a second PC5 connection with the second relay UE for supporting the U2N relay communication, wherein the first relay UE is served by a first cell, detecting a PC5 Radio Link Failure (RLF) on the second PC5 connection or receiving a notification message indicating RLF of a Uu link from the second relay UE, performing a Radio Resource Control (RRC) connection re-establishment procedure to the network, omitting a transmission of a PC5-RRC message or not transmitting the PC5-RRC message to the remote UE if at least the first relay UE keeps being served by the first cell or a serving cell of the remote UE is still the first cell after completing the RRC connection re-establishment procedure, wherein the PC5-RRC message includes information indicating the PC5 RLF or a relay path failure, and transmitting the PC5-RRC message to the remote UE if at least the first relay UE changes to being served by a second cell or the serving cell of the remote UE is changed after completing the RRC connection re-establishment procedure.

### CROSS-REFERENCE TO RELATED APPLICATIONS

The present Application claims priority to and the benefit of U.S. Provisional Patent Application Ser. No. 63/679,997, filed Aug. 6, 2024, which is hereby fully incorporated herein by reference.

### FIELD

This disclosure generally relates to wireless communication networks and, more particularly, to a method and apparatus for sending notification messages in multi-hop User Equipment (UE)-to-network relay communications in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods, systems, and apparatuses are provided for sending notification messages in multi-hop User Equipment (UE)-to-network relay communications by intermediate relays in a wireless communication system.

In various embodiments, a method for a first relay User Equipment (UE) in a wireless communication system comprises establishing a first PC5 connection with a remote UE for supporting a UE-to-Network (U2N) relay communication between the remote UE and a network via the first relay UE and a second relay UE, establishing a second PC5 connection with the second relay UE for supporting the U2N relay communication, wherein the first relay UE is served by a first cell, detecting a PC5 Radio Link Failure (RLF) on the second PC5 connection or receiving a notification message indicating RLF of a Uu link from the second relay UE, performing a Radio Resource Control (RRC) connection re-establishment procedure to the network, omitting a transmission of a PC5-RRC message or not transmitting the PC5-RRC message to the remote UE if at least the first relay UE keeps being served by the first cell or a serving cell of the remote UE is still the first cell after completing the RRC connection re-establishment procedure, wherein the PC5-RRC message includes information indicating the PC5 RLF or a relay path failure, and transmitting the PC5-RRC message to the remote UE if at least the first relay UE changes to being served by a second cell or the serving cell of the remote UE is changed after completing the RRC connection re-establishment procedure.

### BRIEF DESCRIPTION OF THE DRAWINGS

FIG. 1 shows a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5 is a reproduction of FIG. 6.4.3.1-1: Layer-2 link establishment procedure, from 3GPP TS 23.304 [TS23.304].

FIG. 6 is a reproduction of FIG. 6.5.2.2-1: Connection Establishment for 5G ProSe Layer-2 UE-to-Network Relay, from 3GPP TS 23.304 [TS23.304].

FIG. 7 is a reproduction FIG. 16.12.5.1-1: Procedure for L2 U2N Remote UE connection establishment, from 3GPP TS 38.300 [TS38.300].

FIG. 8 is a reproduction of FIG. 5.3.5.1-1: RRC reconfiguration, successful, from 3GPP TS 38.331 [TS38.331].

FIG. 9 is a reproduction of FIG. 5.3.7.1-1: RRC connection re-establishment, successful, from 3GPP TS 38.331 [TS38.331].

FIG. 10 is a reproduction of FIG. 5.8.9.8.1-1: Notification message in sidelink, from 3GPP TS 38.331 [TS38.331].

FIG. 11 is a reproduction of FIG. 6.1.1-1: Example architecture of multi-hop UE-to-Network Relay, from 3GPP TR 23.700-03 [TR23.700-03].

FIG. 12 is a reproduction of FIG. 6.1.2.1.1-1: Example Model A Discovery operation supporting multi-hop UE-to-Network Relay, from 3GPP TR 23.700-03 [TR23.700-03].

FIG. 13 is a reproduction of FIG. 6.1.2.1.2-1: Example Model B Discovery operation supporting multi-hop UE-to-Network Relay, from 3GPP TR 23.700-03 [TR23.700-03].

FIG. 14 is a reproduction of FIG. 6.1.2.5-1: Mobility of the 5G ProSe Remote UE with multi-hop UE-to-Network Relays, from 3GPP TR 23.700-03 [TR23.700-03].

FIG. 15 is a reproduction of FIG. 6.1.2.6.2.2-1: End-to-End QoS translation for 5G ProSe multi-hop Layer-3 UE-to-Network Relay operation, from 3GPP TR 23.700-03 [TR23.700-03].

FIG. 16 is an example diagram showing a 2-hop U2N Relay, where one PC5 connection is established between the Remote UE and an Intermediate U2N Relay (Relay1), another PC5 connection is established between the Intermediate U2N Relay (Relay 1) and a 5G ProSe U2N Relay (Relay2), and an RRC connection is established between the 5G ProSe U2N Relay (Relay2) and the NG-RAN, in accordance with embodiments of the present invention.

FIG. 17A is an example diagram showing an intermediate U2N Relay selecting a suitable relay UE, in accordance with embodiments of the present invention.

FIG. 17B is an example diagram showing an intermediate U2N Relay selecting a suitable cell, in accordance with embodiments of the present invention.

FIG. 18A is an example diagram showing an intermediate U2N Relay selecting a suitable relay UE, in accordance with embodiments of the present invention.

FIG. 18B is an example diagram showing an intermediate U2N Relay selecting a suitable cell, in accordance with embodiments of the present invention.

FIG. 19 is a flow diagram of a method of a first relay UE in a wireless communication system comprising the first relay UE establishes a first PC5 connection with a remote UE for supporting a U2N relay communication between the remote UE and a network via the first relay UE and a second relay UE, the first relay UE establishes a second PC5 connection with the second relay UE for supporting the U2N relay communication, the first relay UE detects a PC5 RLF on the second PC5 connection or receives a notification message indicating Uu RLF from the second relay UE, the first relay UE performs an RRC connection re-establishment procedure to the network, and the first relay UE decides or determines whether to transmit a PC5-RRC message to the remote UE via the first PC5 connection based on the result of the RRC connection re-establishment procedure, in accordance with embodiments of the present invention.

FIG. 20 is a flow diagram of a method of a first relay UE in a wireless communication system comprising establishing a first PC5 connection with a remote UE for supporting a U2N relay communication between the remote UE and a network via the first relay UE and a second relay UE, establishing a second PC5 connection with the second relay UE for supporting the U2N relay communication, detecting a PC5 RLF on the second PC5 connection or receiving a notification message indicating RLF of a Uu link from the second relay UE, performing an RRC connection re-establishment procedure to the network, omitting a transmission of a PC5-RRC message or not transmitting the PC5-RRC message to the remote UE if at least the first relay UE keeps being served by the first cell or a serving cell of the remote UE is still the first cell after completing the RRC connection re-establishment procedure, and transmitting the PC5-RRC message to the remote UE if at least the first relay UE changes to being served by a second cell or the serving cell of the remote UE is changed after completing the RRC connection re-establishment procedure, in accordance with embodiments of the present invention.

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WIMAX®, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: [1] [TS23.304] 3GPP TS 23.304 v18.6.0, “Proximity based Services (ProSe) in the 5G System (5GS) (Release 18)”; [2] [TS38.300] 3GPP TS 38.300 v18.2.0, NR; NR and NG-RAN Overall Description; Stage 2 (Release 18); [3] [TS38.331] 3GPP TS 38.331 v18.2.0 “Radio Resource Control (RRC) protocol specification (Release 18)”; and [4] [TR23.700-03] 3GPP TR 23.700-03 v1.0.0, Study on system enhancement for Proximity based Services (ProSe) in the 5G System (5GS) Phase 3 (Release 19). The standards and documents listed above are hereby expressly and fully incorporated herein by reference in their entirety.

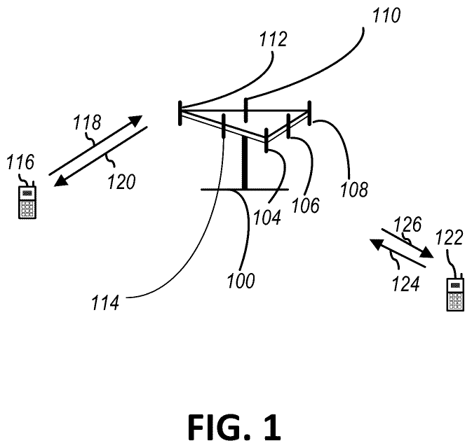

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

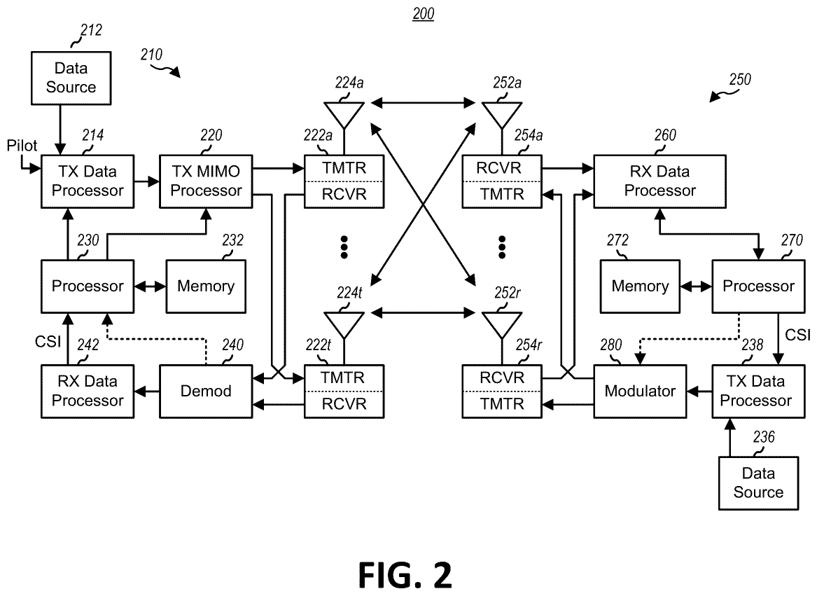

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230. A memory 232 is coupled to processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. Nr modulated signals from transmitters 222a through 222t are then transmitted from N_{T} antennas 224a through 224t, respectively.

At receiver system 250, the transmitted modulated signals are received by NR antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received”symbol stream.

An RX data processor 260 then receives and processes the NR received symbol streams from NR receivers 254 based on a particular receiver processing technique to provide Nr“detected”symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

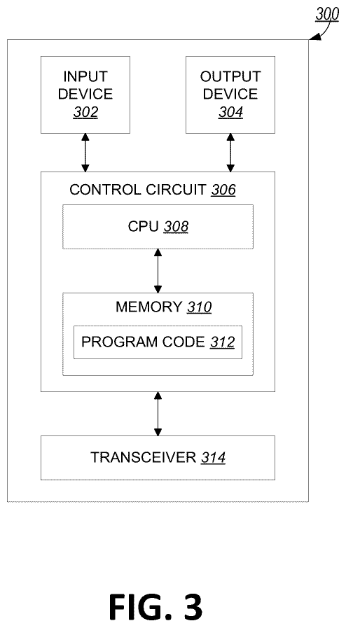

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

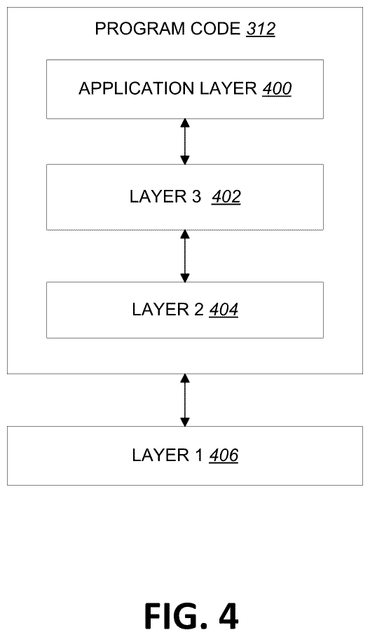

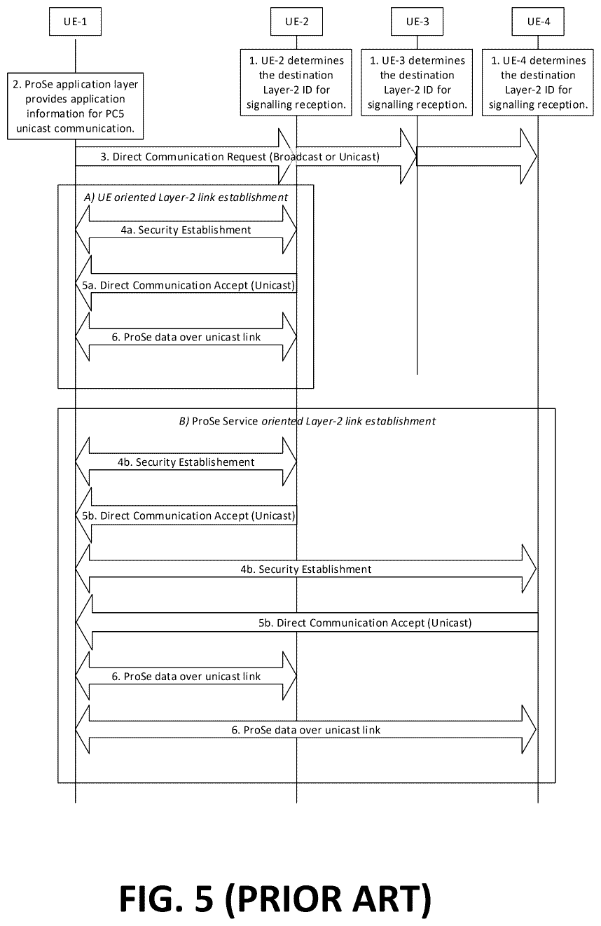

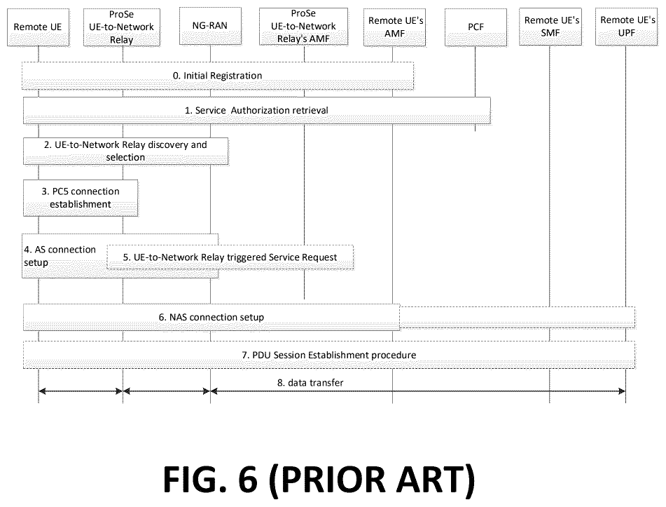

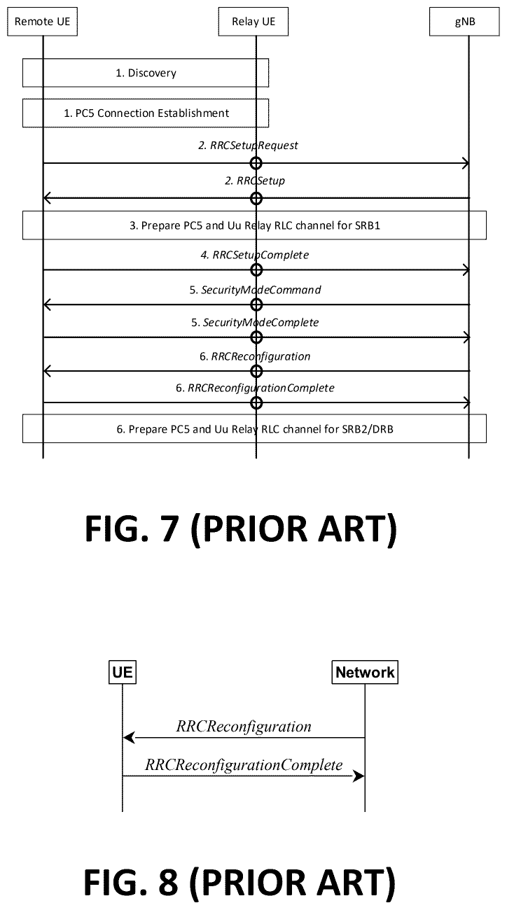

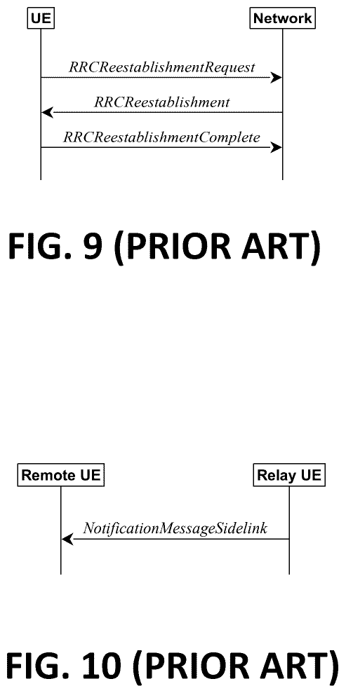

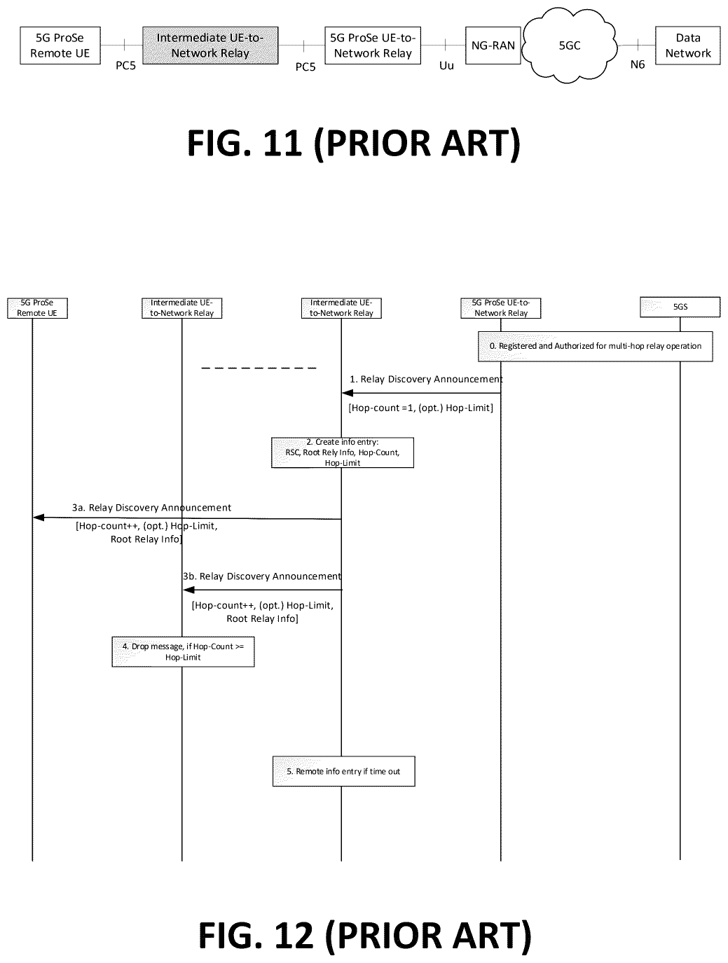

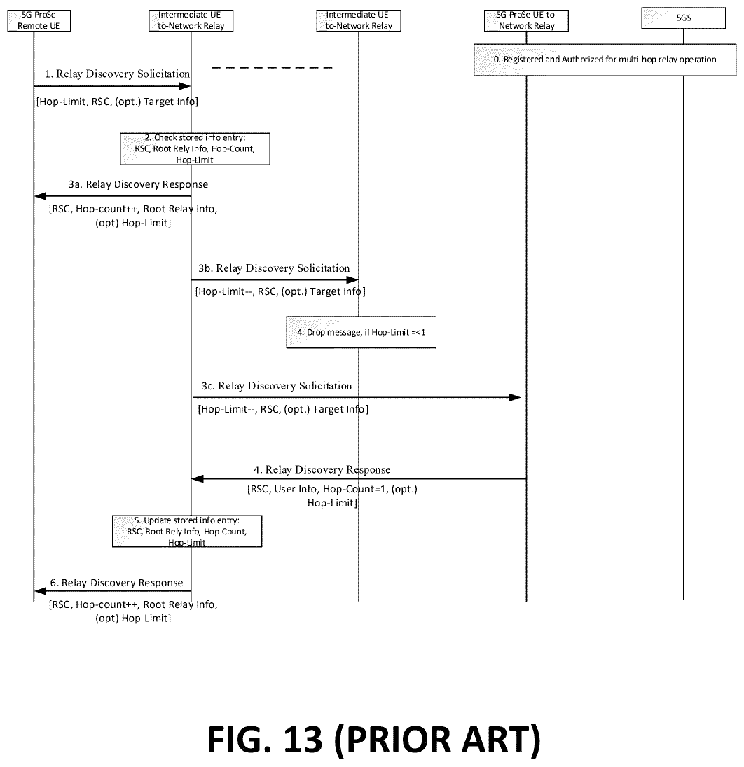

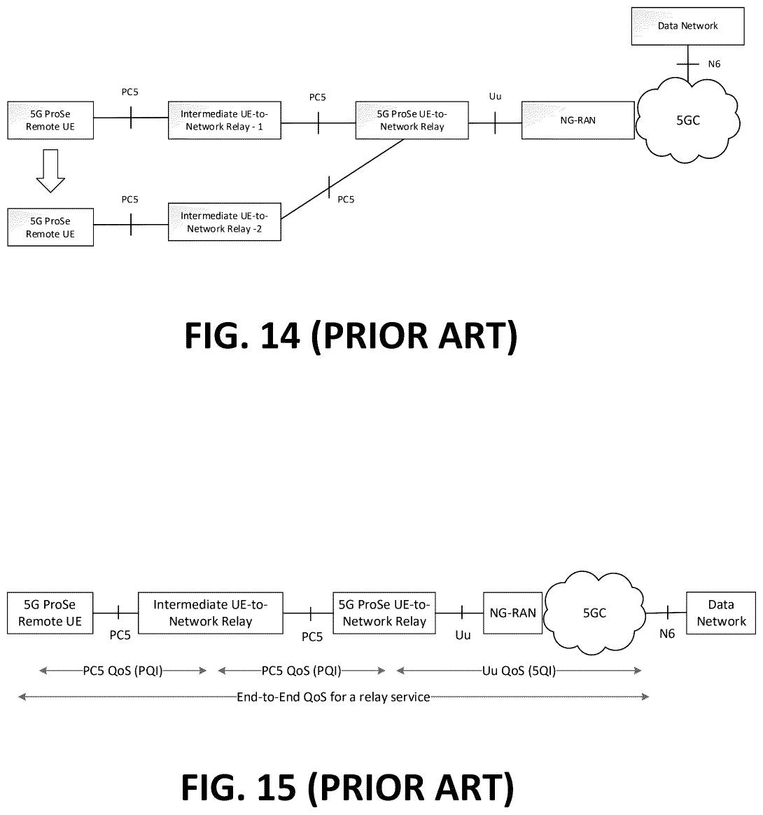

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or NR systems, the Layer 2 portion 404 may include a Radio Link Control (RLC) layer and a Medium Access Control (MAC) layer. The Layer 3 portion 402 may include a Radio Resource Control (RRC) layer.

Any two or more than two of the following paragraphs, (sub-)bullets, points, actions, or claims described in each invention paragraph or section may be combined logically, reasonably, and properly to form a specific method.

Any sentence, paragraph, (sub-)bullet, point, action, or claim described in each of the following invention paragraphs or sections may be implemented independently and separately to form a specific method or apparatus. Dependency, e.g., “based on”, “more specifically”, “example”, etc., in the following invention disclosure is just one possible embodiment which would not restrict the specific method or apparatus.

User Equipment (UE)-to-Network (U2N) Relay was specified in Release 17. A U2N Relay may be used to support connectivity between a remote UE and the network if the remote UE cannot communicate with the network directly or the remote UE is not within coverage of the network. To support connectivity between a remote UE and the network, a U2N Relay may establish a PC5 connection (or a PC5 unicast link) with the remote UE over the PC5 interface and establish a Radio Resource Control (RRC) connection with a network node (e.g., a Next Generation Node B (gNB)) over the Uu interface. During relay communication between the 5G ProSe Remote UE and the network, a Radio Link Failure (RLF) may occur on the Uu interface between the relay UE and the network. As specified in clause 16.12.5 of [2] [TS 38.300] and clause 5.8.9.10 of [3] [TS 38.331], the relay UE may send a PC5-RRC message (i.e., a NotificationMessageSidelink message) to notify the remote UE about the RLF of the Uu connection. In response to the message, the remote UE may trigger an RRC connection re-establishment to re-establish the RRC connection with the network directly or via other U2N Relays.

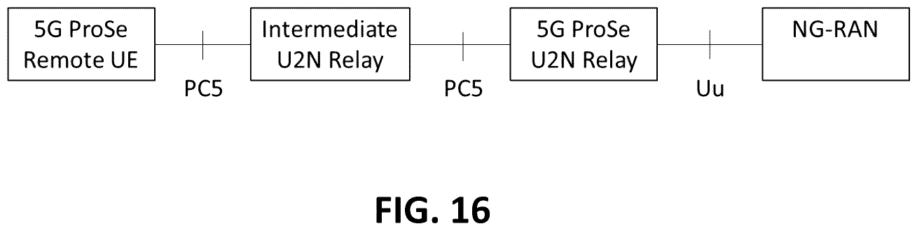

According to [4] [TR 23.700-03], multi-hop U2N Relay will be introduced in Release 19. A 5G ProSe Remote UE may communicate with the network via one 5G Proximity Services (ProSe) U2N Relay and at least one Intermediate U2N Relay. FIG. 16 illustrates examples of 2-hop U2N Relay, where one PC5 connection is established between the Remote UE and an Intermediate U2N Relay (Relay1), another PC5 connection is established between the Intermediate U2N Relay (Relay1) and a 5G ProSe U2N Relay (Relay2), and an RRC connection is established between the 5G ProSe U2N Relay (Relay2) and the Next Generation Radio Access Network (NG-RAN). Furthermore, based on solution #1 in [4] [TR 23.700-03], the existing procedure as defined in [1] [TS 23.304] for single-hop U2N Relay operation may be reused in the multi-hop scenario. The remote UE may discover the Intermediate U2N Relay and the 5G ProSe U2N Relay with a Model A discovery procedure or a Model B discovery procedure. After the 5G ProSe U2N Relay and the Intermediate U2N Relay(s) are discovered, the Remote UE may then initiate the Layer-2 link establishment procedure toward the 5G ProSe U2N Relay. Each of the Intermediate UE-to-Network Relays may then need to establish a Layer-2 Link with its parent Intermediate UE-to-Network Relay or the 5G ProSe UE-to-Network Relay, before it can serve the 5G ProSe Remote UE. After all the PC5 connections over the PC5 interfaces and the RRC connection over the Uu interface have been established, the remote UE may be configured with e.g., Radio Bearer (RB) configurations, Sidelink Relay Adaptation Protocol (SRAP) configurations, and/or PC5 Relay Radio Link Control (RLC) channel configurations for uplink traffic transmission and downlink traffic reception via the Intermediate U2N Relay and the 5G ProSe U2N Relay, through an RRC procedure. Also, the Intermediate U2N Relay and the 5G ProSe U2N Relay may be configured with PC5 Relay RLC channel configurations for uplink traffic and downlink traffic forwarding. It supposes that the intermediate U2N relay UE may be in RRC_CONNECTED when serving the remote UE for forwarding uplink/downlink traffic. It also supposes that the 5G ProSe U2N relay, the Intermediate U2N Relay, and the remote UE are served by the same serving cell when they are in RRC_CONNECTED.

For multi-hop U2N Relay, during relay communication between the 5G ProSe Remote UE and the network, RLF may occur on the PC5 connection between the 5G ProSe U2N Relay and the Intermediate U2N Relay, or RLF may occur on the Uu connection between the 5G ProSe U2N relay UE and the network.

In case the Intermediate U2N Relay detects that a PC5 RLF has occurred between the 5G ProSe U2N Relay and itself or receives a notification message indicating a Uu RLF between the 5G ProSe U2N Relay and the network from the 5G ProSe U2N Relay, if the intermediate U2N relay UE follows the legacy concept (as the intermediate U2N relay UE is acting as a role of a remote UE in view of the 5G ProSe U2N relay UE), it may initiate an RRC connection re-establishment procedure with the network. During the RRC connection re-establishment procedure, the Intermediate U2N Relay may perform the cell selection or relay selection procedure, then select either a suitable cell or a suitable 5G ProSe U2N Relay. On the other hand, the intermediate U2N relay UE following the legacy concept (as the intermediate U2N relay UE is acting as a role of a U2U relay UE in view of the remote UE) may send a notification message to the remote UE for indicating the PC5 RLF on the PC5 connection with the ProSe U2N relay UE. In legacy U2N Relay, if any path for relaying is questionable (i.e., RLF occurring on a Uu connection between the network and the U2N relay UE and/or a PC5 connection between the U2N relay UE and the remote UE), the remote UE needs to perform an RRC connection re-establishment procedure. If such legacy concept is followed, in response to reception of the notification message indicating the PC5 RLF with the ProSe U2N relay UE from the intermediate U2N relay UE, the remote UE may also perform an RRC connection re-establishment procedure that would cause signaling overhead and increase latency.

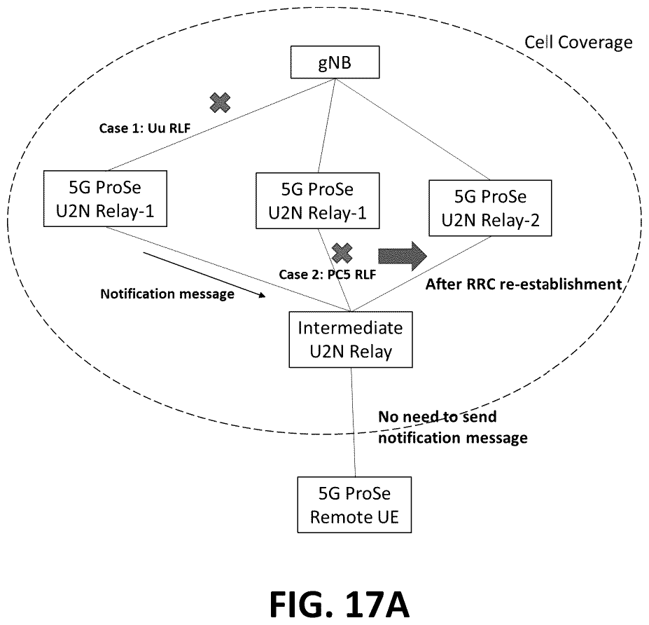

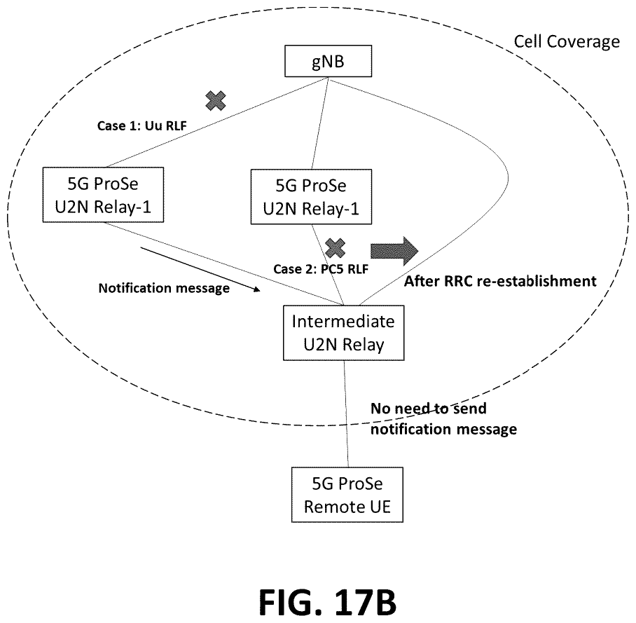

In the RRC connection re-establishment procedure performed between the Intermediate U2N Relay and the network, it is possible that the new serving cell of the Intermediate U2N Relay is the same as the previous one, no matter whether the Intermediate U2N Relay selects the current serving cell as a suitable cell or selects another 5G ProSe U2N Relay as a suitable relay UE which is also served by (or connects to) the current serving cell of the Intermediate U2N Relay. Since the serving cell of the Intermediate U2N Relay is not changed, it implies that the serving cell of the remote UE is not changed as well and, thus, the remote UE may not need to initiate the RRC re-establishment procedure (i.e., the remote UE can keep the current configured RB configurations, SRAP configurations, and/or PC5 Relay RLC channel configurations). To achieve this, if/when the new serving cell of the Intermediate U2N Relay is the same as the previous one (after the RRC connection re-establishment procedure is completed), the Intermediate U2N Relay may not (need to) send a PC5-RRC message (e.g., a NotificationMessageSidelink message) to notify the remote UE about the RLF of the PC5 connection between the 5G ProSe U2N Relay and the Intermediate U2N Relay, the RLF of the Uu connection between the 5G ProSe U2N Relay and the network, and/or the RLF of the Uu connection between the remote UE and the network. In this way, the signaling cost between the remote UE and the network may be reduced. Examples are shown in FIG. 17A and FIG. 17B. In FIG. 17A and FIG. 17B, the Intermediate U2N Relay could be in the coverage of the serving cell. It is noted that the Intermediate U2N Relay may be out of the coverage of the serving cell.

On the other hand, if the new serving cell of the Intermediate U2N Relay is different from the previous one (after the RRC connection re-establishment procedure (performed by the Intermediate U2N Relay) is (successfully) completed), the remote UE may need to be reconfigured with RB configurations, SRAP configurations, and/or PC5 Relay RLC channel configurations by the network. In this case, the Intermediate U2N Relay may still send a PC5-RRC message (e.g., a NotificationMessageSidelink message or a new PC5-RRC message) (after the RRC connection re-establishment procedure (performed by the Intermediate U2N Relay) is (successfully) completed) to notify the remote UE. The PC5-RRC message may indicate about the RLF of the PC5 connection between the 5G ProSe U2N Relay and the Intermediate U2N Relay, the RLF of the Uu connection between the 5G ProSe U2N Relay and the network, the RLF of the Uu connection between the remote UE and the network, serving cell of the remote is/has been changed, an RRC re-establishment procedure needs to be performed, and/or whether cell selection and/or relay selection (during an RRC re-establishment procedure) is needed or not. In response to reception of the PC5-RRC message, the remote UE may initiate the RRC re-establishment procedure.

It is also possible that during the RRC connection re-establishment procedure performed by the Intermediate U2N Relay, no suitable cell and/or a suitable 5G ProSe U2N Relay can be found/selected. Or the RRC connection re-establishment procedure is not successfully completed (e.g., a timer associated with the RRC connection re-establishment procedure (e.g., T301 or T311) expires). In this case, the Intermediate U2N Relay may still send a PC5-RRC message (e.g., a NotificationMessageSidelink message) (after the RRC connection re-establishment procedure (performed by the Intermediate U2N Relay) is not (successfully) completed) to notify the remote UE. The PC5-RRC message may indicate about the RLF of the PC5 connection between the 5G ProSe U2N Relay and the Intermediate U2N Relay, the RLF of the Uu connection between the 5G ProSe U2N Relay and the network, the RLF of the Uu connection between the remote UE and the network, an RRC re-establishment procedure needs to be performed, and/or whether cell selection and/or relay selection (during the RRC re-establishment procedure) is needed or not. In response to reception of the PC5-RRC message, the remote UE may initiate the RRC re-establishment procedure.

During the RRC re-establishment procedure (performed by the remote UE), the remote UE may determine whether to perform cell selection and/or relay selection or not based on (an indication in) the PC5-RRC message. For example, in the case that Uu/PC5 connection between the Intermediate U2N Relay and the network is recovered/re-established, the PC5-RRC message may indicate that cell selection and/or relay selection (during an RRC re-establishment procedure) is not needed. In the case that Uu/PC5 connection between the Intermediate U2N Relay and the network is not (or cannot be) recovered/re-established, the PC5-RRC message may indicate that cell selection and/or relay selection (during the RRC re-establishment procedure) is needed.

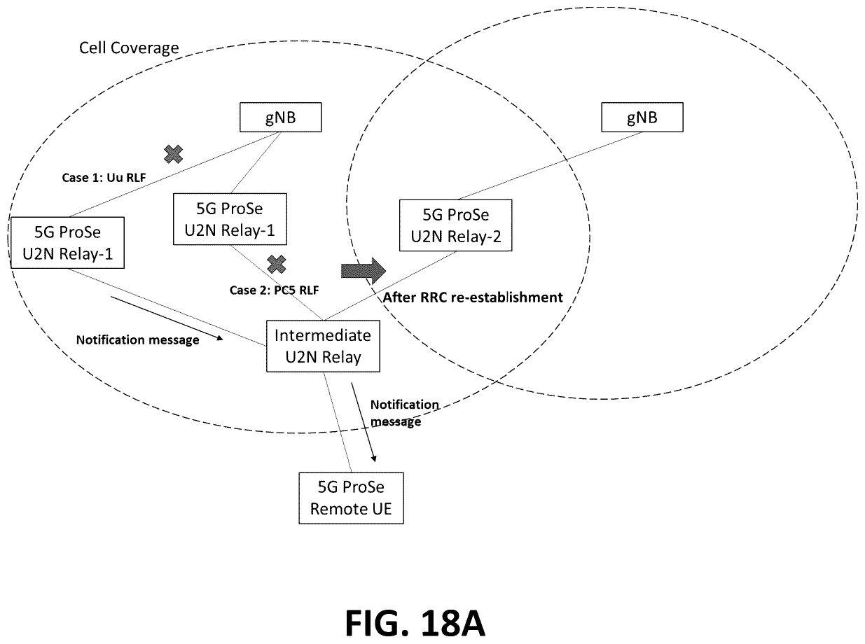

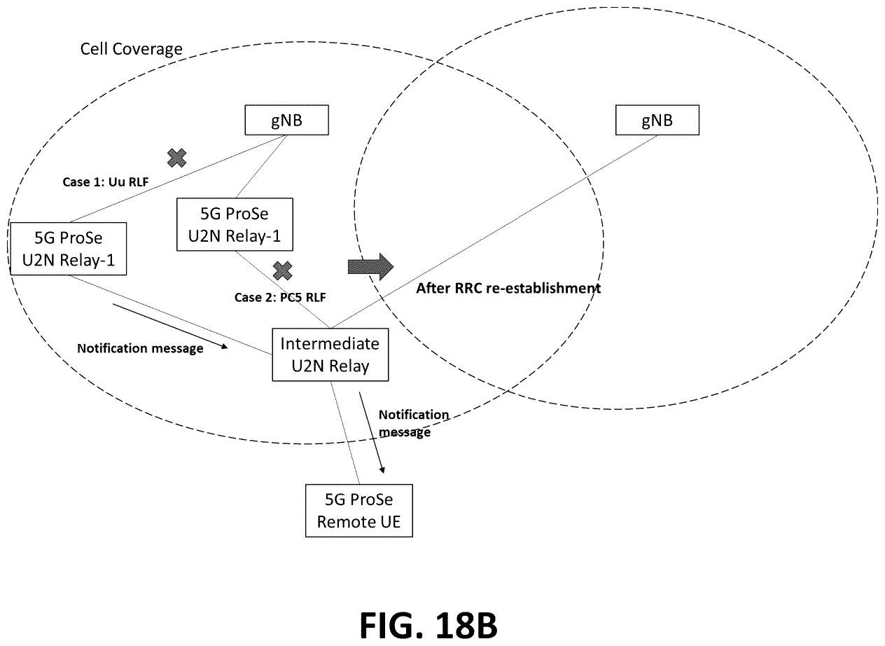

Examples are shown in FIG. 18A and FIG. 18B. In FIG. 18A and FIG. 18B, the Intermediate U2N Relay could be in the coverage of the serving cell. It is noted that the Intermediate U2N Relay may be out of the coverage of the serving cell.

Various examples and embodiments of the present invention are described below. For the methods, alternatives, concepts, examples, and embodiments detailed above and herein, the following aspects and embodiments are possible.

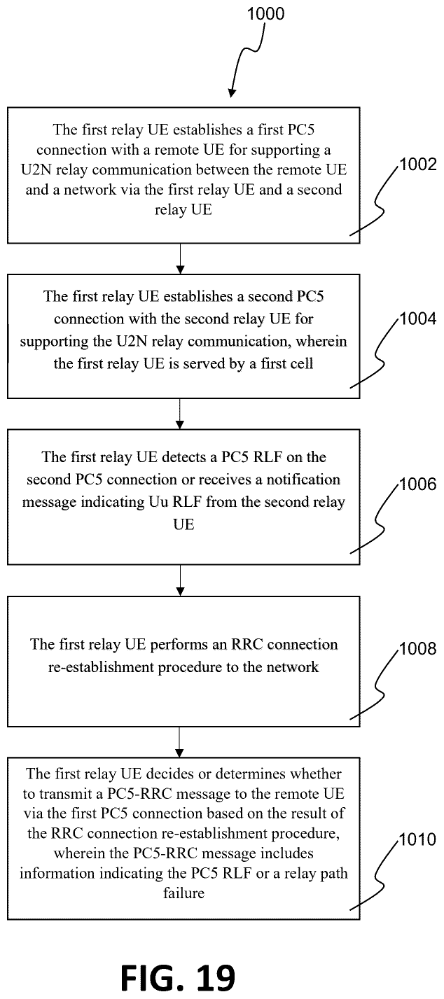

Referring to FIG. 19, with this and other concepts, systems, and methods of the present invention, a method 1000 for a first relay UE in a wireless communication system comprises the first relay UE establishes a first PC5 connection with a remote UE for supporting a U2N relay communication between the remote UE and a network via the first relay UE and a second relay UE (step 1002), the first relay UE establishes a second PC5 connection with the second relay UE for supporting the U2N relay communication, wherein the first relay UE is served by a first cell (step 1004), the first relay UE detects a PC5 RLF on the second PC5 connection or receives a notification message indicating Uu RLF from the second relay UE (step 1006), the first relay UE performs an RRC connection re-establishment procedure to the network (step 1008), and the first relay UE decides or determines whether to transmit a PC5-RRC message to the remote UE via the first PC5 connection based on the result of the RRC connection re-establishment procedure, wherein the PC5-RRC message includes information indicating the PC5 RLF or a relay path failure (step 1010).

In various embodiments, the method further comprises the first relay UE transmits the PC5-RRC message to the remote UE if the first relay UE changes to a second cell after completing the RRC connection re-establishment procedure.

In various embodiments, the method further comprises the first relay UE transmits the PC5-RRC message to the remote UE if the first relay UE fails to select a suitable cell or a suitable U2N relay in the RRC connection re-establishment procedure or the RRC connection re-establishment procedure fails.

In various embodiments, the method further comprises the first relay UE transmits no PC5-RRC message or does not transmit the PC5-RRC message to the remote UE if the first relay UE keeps in the first cell after completing the RRC connection re-establishment procedure.

In various embodiments, the method further comprises the first relay UE performs a cell selection and/or a relay selection in the RRC connection re-establishment procedure, wherein the first relay UE selects a suitable cell or a third relay UE as a suitable relay UE.

In various embodiments, the PC5 RRC message is a NotificationMessageSidelink message.

In various embodiments, the relay path failure means that one of the per-hop PC5 links between the first relay UE and the second relay UE and/or the Uu link between the first relay UE and the network has failed.

In various embodiments, the first relay UE is an Intermediate U2N Relay.

In various embodiments, the second/third relay UE is a 5G ProSe U2N Relay.

In various embodiments, the first relay UE served by a first cell means the first relay UE camps on the first cell and/or the first relay UE connects to the first cell.

Referring back to FIGS. 3 and 4, in one or more embodiments from the perspective of a first relay UE in a wireless communication system, the device 300 includes a program code 312 stored in memory 310 of the transmitter. The CPU 308 could execute program code 312 to: (i) establish a first PC5 connection with a remote UE for supporting a U2N relay communication between the remote UE and a network via the first relay UE and a second relay UE; (ii) establish a second PC5 connection with the second relay UE for supporting the U2N relay communication, wherein the first relay UE is served by a first cell; (iii) detect a PC5 RLF on the second PC5 connection or receives a notification message indicating Uu RLF from the second relay UE; (iv) perform an RRC connection re-establishment procedure to the network; and (v) decide or determine whether to transmit a PC5-RRC message to the remote UE via the first PC5 connection based on the result of the RRC connection re-establishment procedure, wherein the PC5-RRC message includes information indicating the PC5 RLF or a relay path failure. Moreover, the CPU 308 can execute the program code 312 to perform all of the described actions, steps, and methods described above, below, or otherwise herein.

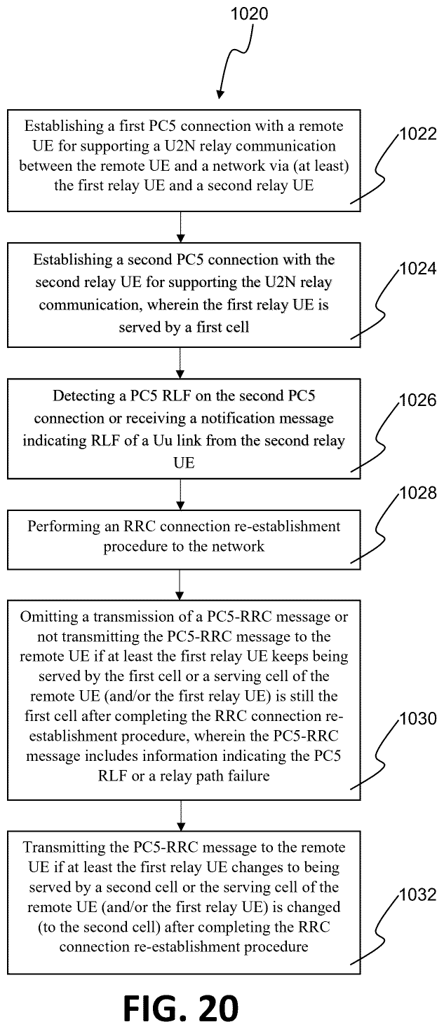

Referring to FIG. 20, with this and other concepts, systems, and methods of the present invention, a method 1020 for a first relay UE in a wireless communication system comprises establishing a first PC5 connection with a remote UE for supporting a U2N relay communication between the remote UE and a network via (at least) the first relay UE and a second relay UE (step 1022), establishing a second PC5 connection with the second relay UE for supporting the U2N relay communication, wherein the first relay UE is served by a first cell (step 1024), detecting a PC5 RLF on the second PC5 connection or receiving a notification message indicating RLF of a Uu link from the second relay UE (step 1026), performing an RRC connection re-establishment procedure to the network (step 1028), omitting a transmission of a PC5-RRC message or not transmitting the PC5-RRC message to the remote UE if at least the first relay UE keeps being served by the first cell or a serving cell of the remote UE (and/or the first relay UE) is still the first cell after completing the RRC connection re-establishment procedure, wherein the PC5-RRC message includes information indicating the PC5 RLF or a relay path failure (step 1030), and transmitting the PC5-RRC message to the remote UE if at least the first relay UE changes to being served by a second cell or the serving cell of the remote UE (and/or the first relay UE) is changed (to the second cell) after completing the RRC connection re-establishment procedure (step 1032).

In various embodiments, the method further comprises transmitting the PC5-RRC message to the remote UE if at least the first relay UE fails to select a suitable cell or a suitable U2N relay in the RRC connection re-establishment procedure or the RRC connection re-establishment procedure fails.

In various embodiments, the method further comprises performing a cell selection and/or a relay selection during the RRC connection re-establishment procedure, wherein the first relay UE selects a suitable cell or a third relay UE as a suitable relay UE.

In various embodiments, the third relay UE is a last U2N relay UE.

In various embodiments, the notification message is a NotificationMessageSidelink message.

In various embodiments, the PC5-RRC message is a NotificationMessageSidelink message.

In various embodiments, the relay path failure means that the second PC5 connection between the first relay UE and the second relay UE fails, the Uu link between the second relay UE and the network fails, and/or the U2N relay communication between the remote UE and the network fails.

In various embodiments, the first relay UE is an intermediate relay UE.

In various embodiments, the second relay UE is a last U2N relay UE.

In various embodiments, the first relay UE being served by the first cell means that the first relay UE camps on the first cell and/or the first relay UE connects to the first cell, and the first relay UE to be served by the second cell means that the first relay UE camps on the second cell and/or the first relay UE connects to the second cell.

Referring back to FIGS. 3 and 4, in one or more embodiments from the perspective of a first relay UE in a wireless communication system, the device 300 includes a program code 312 stored in memory 310 of the transmitter. The CPU 308 could execute program code 312 to: (i) establish a first PC5 connection with a remote UE for supporting a U2N relay communication between the remote UE and a network via (at least) the first relay UE and a second relay UE; (ii) establish a second PC5 connection with the second relay UE for supporting the U2N relay communication, wherein the first relay UE is served by a first cell; (iii) detect a PC5 RLF on the second PC5 connection or receiving a notification message indicating RLF of a Uu link from the second relay UE; (iv) perform an RRC connection re-establishment procedure to the network; (v) omit a transmission of a PC5-RRC message or not transmit the PC5-RRC message to the remote UE if at least the first relay UE keeps being served by the first cell or a serving cell of the remote UE (and/or the first relay UE) is still the first cell after completing the RRC connection re-establishment procedure, wherein the PC5-RRC message includes information indicating the PC5 RLF or a relay path failure; and (vi) transmit the PC5-RRC message to the remote UE if at least the first relay UE changes to being served by a second cell or the serving cell of the remote UE (and/or the first relay UE) is changed (to the second cell) after completing the RRC connection re-establishment procedure. Moreover, the CPU 308 can execute the program code 312 to perform all of the described actions, steps, and methods described above, below, or otherwise herein.

Any combination of the above or herein concepts or teachings can be jointly combined, in whole or in part, or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials.

While the invention has been described in connection with various aspects and examples, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for a first relay User Equipment (UE), comprising:
establishing a first PC5 connection with a remote UE for supporting a UE-to-Network (U2N) relay communication between the remote UE and a network via the first relay UE and a second relay UE;
establishing a second PC5 connection with the second relay UE for supporting the U2N relay communication, wherein the first relay UE is served by a first cell;
detecting a PC5 Radio Link Failure (RLF) on the second PC5 connection or receiving a notification message indicating RLF of a Uu link from the second relay UE;
performing a Radio Resource Control (RRC) connection re-establishment procedure to the network;
omitting a transmission of a PC5-RRC message or not transmitting the PC5-RRC message to the remote UE if at least the first relay UE keeps being served by the first cell or a serving cell of the remote UE is still the first cell after completing the RRC connection re-establishment procedure, wherein the PC5-RRC message includes information indicating the PC5 RLF or a relay path failure; and
transmitting the PC5-RRC message to the remote UE if at least the first relay UE changes to being served by a second cell or the serving cell of the remote UE is changed after completing the RRC connection re-establishment procedure.

2. The method of claim 1, further comprising transmitting the PC5-RRC message to the remote UE if at least the first relay UE fails to select a suitable cell or a suitable U2N relay in the RRC connection re-establishment procedure or the RRC connection re-establishment procedure fails.

3. The method of claim 1, further comprising performing a cell selection and/or a relay selection during the RRC connection re-establishment procedure, wherein the first relay UE selects a suitable cell or a third relay UE as a suitable relay UE.

4. The method of claim 3, wherein the third relay UE is a last U2N relay UE.

5. The method of claim 1, wherein the notification message is a NotificationMessageSidelink message.

6. The method of claim 1, wherein the PC5-RRC message is a NotificationMessageSidelink message.

7. The method of claim 1, wherein the relay path failure means that the second PC5 connection between the first relay UE and the second relay UE fails and/or the Uu link between the second relay UE and the network fails.

8. The method of claim 1, wherein the first relay UE is an intermediate relay UE.

9. The method of claim 1, wherein the second relay UE is a last U2N relay UE.

10. The method of claim 1, wherein the first relay UE being served by the first cell means that the first relay UE camps on the first cell and/or the first relay UE connects to the first cell, and the first relay UE to be served by the second cell means that the first relay UE camps on the second cell and/or the first relay UE connects to the second cell.

11. A first relay User Equipment (UE), comprising:
a memory; and
a processor operatively coupled with the memory, wherein the processor is configured to execute a program code to:
establish a first PC5 connection with a remote UE for supporting a UE-to-Network (U2N) relay communication between the remote UE and a network via the first relay UE and a second relay UE;
establish a second PC5 connection with the second relay UE for supporting the U2N relay communication, wherein the first relay UE is served by a first cell;
detect a PC5 Radio Link Failure (RLF) on the second PC5 connection or receiving a notification message indicating RLF of a Uu link from the second relay UE;
perform a Radio Resource Control (RRC) connection re-establishment procedure to the network;
omit a transmission of a PC5-RRC message or not transmit the PC5-RRC message to the remote UE if at least the first relay UE keeps being served by the first cell or a serving cell of the remote UE is still the first cell after completing the RRC connection re-establishment procedure, wherein the PC5-RRC message includes information indicating the PC5 RLF or a relay path failure; and
transmit the PC5-RRC message to the remote UE if at least the first relay UE changes to being served by a second cell or the serving cell of the remote UE is changed after completing the RRC connection re-establishment procedure.

12. The first relay UE of claim 11, wherein the processor is further configured to execute the program code to transmit the PC5-RRC message to the remote UE if at least the first relay UE fails to select a suitable cell or a suitable U2N relay in the RRC connection re-establishment procedure or the RRC connection re-establishment procedure fails.

13. The first relay UE of claim 11, wherein the processor is further configured to execute the program code to perform a cell selection and/or a relay selection during the RRC connection re-establishment procedure, wherein the first relay UE selects a suitable cell or a third relay UE as a suitable relay UE.

14. The first relay UE of claim 13, wherein the third relay UE is a last U2N relay UE.

15. The first relay UE of claim 11, wherein the notification message is a NotificationMessageSidelink message.

16. The first relay UE of claim 11, wherein the PC5-RRC message is a NotificationMessage Sidelink message.

17. The first relay UE of claim 11, wherein the relay path failure means that the second PC5 connection between the first relay UE and the second relay UE fails and/or the Uu link between the second relay UE and the network fails.

18. The first relay UE of claim 11, wherein the first relay UE is an intermediate relay UE.

19. The first relay UE of claim 11, wherein the second relay UE is a last U2N relay UE.

20. The first relay UE of claim 11, wherein the first relay UE being served by the first cell means that the first relay UE camps on the first cell and/or the first relay UE connects to the first cell, and the first relay UE to be served by the second cell means that the first relay UE camps on the second cell and/or the first relay UE connects to the second cell.
